(19) United States
(12) Patent Application Publication
(10) Pub. No.: US 2013/0078457 A1
(43) Pub. Date: Mar. 28, 2013

(54) METHOD OF FORMING METAL OXIDE FILM, METAL OXIDE FILM AND OPTICAL ELECTRONIC DEVICE

(71) Applicant: PANASONIC CORPORATION, Osaka (JP)

(72) Inventors: Mitsuo SAITOH, Osaka (JP); Tomohiro OKUMURA, Osaka (JP); Osamu MORITA, Osaka (JP)

(73) Assignee: PANASONIC CORPORATION, Osaka (JP)

(21) Appl. No.: 13/683,032

(22) Filed: Nov. 21, 2012

Related U.S. Application Data
(62) Division of application No. 12/090,704, filed on Jul. 8, 2008, now abandoned.

(30) Foreign Application Priority Data
Oct. 19, 2005 (JP) 2005-304165

(51) Int. Cl. B32B 9/04

(52) U.S. Cl. CPC B32B 9/04
USPC 428/336; 428/448

(57) ABSTRACT

A metal oxide film forming method includes mixing an organic metal compound that is a liquid at room temperature and an organic solvent to form a paste, applying the paste onto a substrate, and oxidizing a metal element in the paste while vaporizing organic substances in the paste by irradiating atmospheric pressure plasma to the paste applied onto the substrate to form a metal oxide film. A metal oxide film composed of three layers is formed on a substrate such as a glass substrate. Such a structure can be obtained by repeating the steps of mixing the organic metal compound that is a liquid at room temperature and the organic solvent to form the paste, applying the paste onto the substrate, and oxidizing the metal element while vaporizing the organic substances in the paste. Also contemplated is an optical electronic device using the metal oxide film.

### CROSS-REFERENCE TO RELATED APPLICATION

This application is a divisional of U.S. application Ser. No. 12/090,704, filed Apr. 18, 2008, which is a national stage application of PCT/JP2006/320765, filed Oct. 18, 2006, the entireties of which are incorporated herein by reference.

### BACKGROUND OF THE INVENTION

I. Technical Field

The present invention relates to a metal oxide film, a method for forming the same, and an optical electronic device using the metal oxide film.

II. Description of the Related Art

Metal oxide films are widely used in electronic devices such as an interlayer insulating film of a semiconductor. Among these, silicon oxide films have a wide range of uses, and particularly in semiconductor devices, they are used actively since a dense silicon oxide film having high withstand voltage can be easily obtained by use of a plasma CVD (Chemical Vapor Deposition) method.

FIG. 7 is a sectional view showing a constitution of a plasma CVD apparatus. In FIG. 7, a substrate 101 is disposed on a lower electrode 110 in a vacuum vessel 109. A silicon oxide film can be formed on the substrate 101 by supplying high-frequency power of 13.56 MHz from a high-frequency power source for an upper electrode 113 to an upper electrode 111 and supplying high-frequency power of 1 MHz from a high-frequency power source for a lower electrode 114 to the lower electrode 110 while feeding TEOS (tetraethyl-ortho-silicate or tetraethoxysilane, this is also referred to as ethyl silicate and its chemical formula is Si(OC₂H₅)₄) gas, He gas, and O₂ gas from a gas feeding apparatus not shown through a shower head 112 disposed below the upper electrode 111 with maintaining a pressure in the vacuum vessel 109 at a predetermined level by evacuating the vessel 109 with a pump not shown

On the other hand, as a film which is transparent to visible light as well as the glass film, a magnesium oxide thin film is known. FIG. 8 is a sectional view of an apparatus for forming a magnesium oxide thin film at normal pressure. In FIG. 8, a reference numeral 115 indicates a reaction vessel for forming a thin film at normal pressure and a heating stage 116 incorporating a panel heater is disposed inside the vessel. An object to be treated (substrate) 101 such as a glass substrate, targeted for forming a protective film, with a 50 inches diagonal at the maximum is placed and held on this heating stage 116. The reaction vessel 115 is equipped with a feeding nozzle 118 for feeding atomized fine particles 117 to the inside thereof and the feeding nozzle 118 is configured so as to supply the atomized fine particles 117 uniformly through an atomized fine particles equal distribution plate 119 to the object to be treated 101. The feeding nozzle 118 is connected to an atomizing vessel 121 through an atomized fine particle inlet pipe 120.

In the atomizing vessel 121, an ultrasonic oscillator 122 is built-in and a liquid raw material 123 made of a solution of an organic magnesium compound is contained, and the atomizing vessel 121 is configured so as to generate the atomized fine particles 117 with ultrasonic wave. The atomizing vessel 121 is configured so as to introduce a carrier gas 124 made of oxygen or an inert gas and configured so as to carry the atomized fine particles 117 generated with the introduced carrier gas 124 to supply the atomized fine particles 117 through the atomized fine particle inlet pipe 120 to the reaction vessel 115.

The atomizing vessel 121 is connected to a buffer vessel 125 which can blend automatically, on the outside of the atomizing vessel 121, and the liquid raw material 123 is configured so as to circulate between the atomizing vessel 121 and the buffer vessel 125. The atomizing vessel 121 is equipped with a concentration detector 126 in order to keep the concentration of the liquid raw material 123 at a constant level. A reference numeral 127 indicates a liquid level sensor.

A heater 128 for controlling a temperature of an atmosphere and the atomized fine particles 117 within the feeding nozzle 118 is installed on the surface of the feeding nozzle 118. An equal exhaust pipe 129 to exhaust to the outside fine particles in atomized form, which have not contributed to the formation of the film is attached to the feeding nozzle 118 (for example, refer to Japanese Unexamined Patent Publication No. 2000-215797).

As a method for forming a glass film having a relatively large thickness of 10 μm or more, a method of using a paste including glass particles mixed is known. FIGS. 9A to 9C are views showing a process for forming a layer in an example of the method and a front-side substrate of an AC type PDP of a three-electrode structure is exemplified. In FIG. 9A, display electrodes 130 are formed on the glass substrate 101 on the front side by a photolithography technique.

Thereafter, a dielectric paste 131 is applied onto the glass substrate 101 so as to cover the display electrodes 130 by screen printing. As shown in FIG. 9A, the dielectric paste 131 is composed of glass particles 132 being a dielectric material and a liquid material 133. The glass particles 132 is prepared by milling dielectric glass for a predetermined time with a ball mill, and milled glass particles are separated by a centrifuge and only particles having a diameter smaller than a film thickness of the dielectric layer to be formed are selected. The liquid material 133 includes a binder for binding the glass particles 132 and a solvent for adjusting the viscosity of the paste, and glass particles 132 are evenly distributed by kneading the liquid material 133 with a common kneader.

After applying such a dielectric paste 131, the paste is dried to evaporate the solvent contained in the dielectric paste 131 to achieve a state shown in FIG. 9B, in which the glass particles 132 are bound by the binder 134.

The binder 134 is eliminated by burning the binder 134 by a firing treatment to obtain a dielectric layer 135 as shown in FIG. 9C. In this example, since it is necessary to transmit visible light (luminescence of phosphor), the dielectric layer 135 is transparent as with the glass substrate 101. The firing treatment consists of a first heating treatment of about 350° C. to burn the binder 134 and a second heating treatment of about 500° C. to melt only the surface portions of the glass particles 132 and fix the glass particles 132 to one another. This firing temperature is set at a temperature at which a dielectric material is melted and is not fused with the display electrodes 130 (for example, refer to Japanese Unexamined Patent Publication No. 11-167861).

Further, as a method for forming a film of metal oxide glass having a thickness of several micrometers (μm) without using glass particles, a method of using a mixed material of boron ions and halogen ions is known. In this method, tetraethoxysilane Si(OEt)₄ and a mixed solvent consisting of water, methanol, ethanol, and isopropanol are further mixed in the proportion of 5:1 by weight, and triethoxyboran B(OEt)₃ is added to the resulting mixture to prepare a main material, and the main material and a catalyst are mixed in the proportion of 3:1, and the resulting mixture is subjected to hydrolysis and dehydration condensation for 3 hours while adjusting a pH. The resulting product is applied to a substrate, dried and fired to form a glass film having a thickness of about 4 μm. In addition, a firing temperature at this time is 200° C. or less (for example, refer to Japanese Patent Publication No. 2538527).

### SUMMARY OF THE INVENTION

However, in conventional metal oxide films, there is an issue that it is impossible to form a dense film, which is thick and has high withstand voltage characteristics, at low temperatures at high speed.

A dense silicon oxide film having high withstand voltage characteristics can be formed by a plasma CVD method, but it is extremely difficult to form a thick film having a thickness of 2 μm or more. Though a method for forming a thick film by precisely controlling film stress has been investigated, a film growth rate is 100 nm/min or less and, for example, it takes 1 hour or more to form a film having a thickness of 10 μm in this method. Further, this method is based on vacuum plasma, it requires expensive vacuum equipment leading to cost increase, and is low in a plasma density and takes much time to produce a vacuum, and therefore this method has low productivity.

The method shown in Japanese Unexamined Patent Publication No. 2000-215797 pertains to a magnesium oxide film, but the dense silicon oxide film, which is thick and has high withstand voltage characteristics, cannot be formed at high speed simply by replacing the liquid raw material with TEOS.

Further, by the method shown in Japanese Unexamined Patent Publication No. 11-167861, a thick glass film can be formed at high speed, but since a binder cannot be thoroughly eliminated to remain slightly and bubbles are produced, the formed glass film does not become homogeneous and dense and therefore high withstand voltage characteristics cannot be achieved.

Further, by the method shown in Japanese Patent Publication No. 2538527, a thick glass film can be formed at low temperatures, but it takes very much time to prepare a solvent and perform hydrolysis. Since many impurities such as boron, halogens, and a pH adjuster are present in a large amount, it is impossible to form a dense SiO₂ film of high purity and attain high withstand voltage characteristics.

In view of the above-mentioned conventional issues, it is an object of the present invention to provide a method for forming a metal oxide film, by which the metal oxide film which is, for example, as thick as 1 μm or more and has high withstand voltage characteristics can be formed at low temperatures and at high speed, the metal oxide film which is thick and has high withstand voltage characteristics, and an optical electronic device which uses this metal oxide film and has excellent optical characteristics.

It is an object to provide particularly a method for forming a glass film as an example of a metal oxide film, in which visible transmittance is high, and dense and moderate light scattering is attained, at low temperatures and at high speed as an example of the above-described method for forming a metal oxide film, particularly a glass film in which visible transmittance is high, and dense and moderate light scattering is attained as an example of the foregoing metal oxide film which is thick and has high withstand voltage characteristics, and an optical electronic device which uses this glass film and has excellent optical characteristics, as a more specific aspect of the present invention.

### Means for Solving the Subject

In order to achieve the above-mentioned objects, the present invention is constituted as follows.

According to a first aspect of the present invention, there is provided a method for forming a metal oxide film comprising:

a first step of mixing an organic metal compound that is a liquid at room temperature and an organic solvent to form a paste;

a second step of applying materials formed into the paste in the first step onto a substrate; and

a third step of oxidizing a metal element in the materials while vaporizing organic substances in the materials of the paste by irradiating atmospheric pressure plasma to the paste applied onto the substrate after the second step to form a metal oxide film.

By such a configuration, a metal oxide film which is thick and has high withstand voltage characteristics can be formed at low temperatures and at high speed, and particularly a glass film, in which visible transmittance is high, and dense and moderate light scattering is attained, can be formed at low temperatures and at high speed.

In accordance with one aspect of the present invention, it is desirable that the above-described metal oxide film is suitably an insulating film in the above-mentioned aspect.

By such a configuration, the metal oxide film which is thick and has high withstand voltage characteristics can be formed at low temperatures and at high speed.

Further, in accordance with one aspect of the present invention, it is desirable that the foregoing metal oxide film is suitably a glass film in the above-mentioned aspect.

By such a configuration, the metal oxide film which is thick and has high withstand voltage characteristics can be formed at low temperatures and at high speed, and particularly the glass film, in which visible transmittance is high, and dense and moderate light scattering is attained, can be formed at low temperatures and at high speed.

In accordance with a second aspect of the present invention, it is desirable that the foregoing organic metal compound that is a liquid at room temperature is suitably an organic silicon compound in the first aspect.

By such a configuration, the metal oxide film which is thick and has high withstand voltage characteristics can be formed at low temperatures and at high speed.

In accordance with a third aspect of the present invention, it is desirable that the foregoing organic silicon compound is suitably TEOS (tetraethyl-ortho-silicate) or HMDSO (hexamethyldisiloxane) in the second aspect.

By such a configuration, the metal oxide film which is thick and has high withstand voltage characteristics can be formed at low temperatures and at high speed.

Further, in accordance with a fourth aspect of the present invention, it is desirable that in the first aspect, a volume ratio of the foregoing organic solvent in the materials formed into the foregoing paste is suitably 10% or more and 80% or less in the first step.

In accordance with a fifth aspect of the present invention, it is desirable that in the fourth aspect, a volume ratio of the foregoing organic solvent in the materials formed into the foregoing paste is further suitably 20% or more and 60% or less in the first step.

By such a configuration, the metal oxide film which is thick and has high withstand voltage characteristics can be formed at low temperatures and at high speed, and particularly the glass film, in which visible transmittance is high, and dense and moderate light scattering is attained, can be formed at low temperatures and at high speed.

Further, in accordance with one aspect of the present invention, it is preferable that in the above-mentioned aspect, the foregoing organic solvent is suitably composed of a solvent component alone, a resin component alone, or a mixture of a solvent component and a resin component, and it is preferable that as the foregoing solvent component, one kind or a mixture of two or more kinds of terpenes such as α-, β-, and γ-terpineol, ethyleneglycolmonoalkyl ethers, ethyleneglycoldialkyl ethers, diethyleneglycolmonoalkyl ethers, diethyleneglycoldialkyl ethers, ethylene glycol monoalkyl ether acetates, ethylene glycol dialkyl ether acetates, diethylene glycol monoalkyl ether acetates, diethylene glycol dialkyl ether acetates, propylene glycol monoalkyl ethers, propylene glycol dialkyl ethers, propylene glycol monoalkyl ether acetates, propylene glycol dialkyl ether acetates, and alcohols such as methanol, ethanol, isopropanol, 1-butanol, and the like is suitably used, and it is preferable that as the foregoing resin component, one kind or a mixture of two or more kinds of cellulose resins such as nitrocellulose, ethyl cellulose, and hydroxyethylcellulose, acrylic resin or acrylic copolymer such as polybutylacrylate and polymethacrylate, polyvinyl alcohol, and polyvinyl butyral is further suitably used.

By such a configuration, the metal oxide film which is thick and has high withstand voltage characteristics can be formed at low temperatures and at high speed, and particularly the glass film, in which visible transmittance is high, and dense and moderate light scattering is attained, can be formed at low temperatures and at high speed.

Further, in accordance with a sixth aspect of the present invention, it is preferable that the viscosity of the materials formed into the foregoing paste is suitably larger than that of an organic metal compound in the first aspect, and it is preferable that the viscosity of the materials formed into the foregoing paste is further suitably 10 mPa·s or more and 50 Pa·s or less at room temperature, and in a seventh aspect of the present invention, it is preferable that in the sixth aspect, the viscosity of the materials formed into the foregoing paste is further suitably 50 mPa·s or more and 1 Pa·s or less at room temperature.

By such a configuration, the metal oxide film which is thick and has high withstand voltage characteristics can be formed at low temperatures and at high speed, and particularly the glass film, in which visible transmittance is high, and dense and moderate light scattering is attained, can be formed at low temperatures and at high speed.

Further, in accordance with one aspect of the present invention, it is characterized in that in the above-mentioned aspect, the foregoing paste prior to application to the foregoing substrate is suitably in a state of being deaerated by a vacuum deaeration method.

Further, in accordance with one aspect of the present invention, it is preferable that in the above-mentioned aspect, the foregoing paste is suitably applied onto the foregoing substrate by any of a screen printing method, a spray method, a blade coater method, a die coating method, a spin coating method, an ink-jet method, and a sol-gel method in the foregoing step of applying the foregoing paste onto the foregoing substrate.

By such a configuration, the metal oxide film which is thick and has high withstand voltage characteristics can be formed at low temperatures and at high speed, and particularly the glass film, in which visible transmittance is high, and dense and moderate light scattering is attained, can be formed at low temperatures and at high speed.

Further, in accordance with one aspect of the present invention, it is preferable that in the above-mentioned aspect, the first step of applying the foregoing paste onto the foregoing substrate and the second step of oxidizing the foregoing metal element in the foregoing paste while vaporizing the foregoing organic substances in the foregoing paste are suitably alternately repeated more than once, and it is preferable that in the first step of applying the foregoing paste onto the foregoing substrate, a film thickness of the paste applied once is 1 μm or more and 10 μm or less.

By such a configuration, the metal oxide film which is thick and has high withstand voltage characteristics can be formed at low temperatures and at high speed, and particularly the glass film, in which visible transmittance is high, and dense and moderate light scattering is attained, can be formed at low temperatures and at high speed.

Further, in accordance with an eighth aspect of the present invention, it is characterized in that in the first aspect, the foregoing metal element in the foregoing materials is suitably oxidized while vaporizing the foregoing organic substances in the foregoing materials by irradiating the foregoing atmospheric pressure plasma to the foregoing paste with use of a gas containing oxygen and fluorine in the third step.

Further, in accordance with one aspect of the present invention, it is preferable to suitably comprise a step of further irradiating heat energy or active particles to the foregoing metal oxide film formed in the foregoing step of oxidizing the foregoing metal element in the foregoing paste while vaporizing the foregoing organic substances in the foregoing paste in the above-mentioned aspect, and it is preferable that the foregoing atmospheric pressure plasma is further suitably used in the step of irradiating heat energy or active particles.

By such a configuration, the metal oxide film which is thick and has high withstand voltage characteristics can be formed at low temperatures and at high speed, and particularly the glass film, in which visible transmittance is high, and dense and moderate light scattering is attained, can be formed at low temperatures and at high speed.

Further, in accordance with a ninth aspect of the present invention, it is preferable to suitably comprise a fourth step of further depositing a second metal oxide film (for example, SiO₂) on the foregoing metal oxide film formed in the third step by a CVD method in the first aspect.

Further, in accordance with a tenth aspect of the present invention, it is preferable that in the ninth aspect, an atmospheric pressure plasma CVD method is further suitably employed in the fourth step.

By such a configuration, the metal oxide film which is thick and has high withstand voltage characteristics can be formed at low temperatures and at high speed, and particularly the glass film, in which visible transmittance is high, and dense and moderate light scattering is attained, can be formed at low temperatures and at high speed. By forming a next metal oxide film after further depositing the second metal oxide film (for example, SiO₂) on the metal oxide film by a CVD method, an interface can be formed between the second metal oxide film (for example, SiO₂) and the next metal oxide film, for example, between the same SiO₂ films and therefore an adhesive force between the first metal oxide film and the second metal oxide film can be improved.

Further, in accordance with one aspect of the present invention, it is preferable that in the above-mentioned aspect, the foregoing substrate is suitably a bulk, a substrate, a film, or a sheet, having an organic substance as the main component.

By such a configuration, the metal oxide film which is thick and has high withstand voltage characteristics can be formed at low temperatures and at high speed, and particularly the glass film, in which visible transmittance is high, and dense and moderate light scattering is attained, can be formed at low temperatures and at high speed.

Further, in accordance with an eleventh aspect of the present invention, it is preferable that in the eighth aspect, an inert gas is suitably included in the proportion of 80% or more and 99.9% or less in a gas for atmospheric pressure plasma treatment in the foregoing atmospheric pressure plasma. Further, in accordance with a twelfth aspect of the present invention, it is preferable that in the eleventh aspect, the foregoing inert gas is further suitably any of He, Ar, Ne, Kr, Xe, and Rn gases. Among these, particularly when the inert gas is He or Ar, since it is economically advantageous and also advantageous in terms of stability of plasma formation, it is preferable.

By such a configuration, the metal oxide film which is thick and has high withstand voltage characteristics can be formed at low temperatures and at high speed, and particularly the glass film, in which visible transmittance is high, and dense and moderate light scattering is attained, can be formed at low temperatures and at high speed.

Further, in accordance with a thirteenth aspect of the present invention, it is preferable that in the eighth aspect, the foregoing atmospheric pressure plasma suitably includes an O₂ gas in the gas for atmospheric pressure plasma treatment and includes at least one kind of gas containing carbon (C) elements or fluorine (F) elements, and it is preferable that the gas containing carbon elements is further suitably any one of gases of CH₄, CHF₃, CO₂, CO, CF₄, C₂F₄, C₂F₆, C₃F₆, C₄F₆, C₃F₈, C₄F₈, C₅F₈, C₂H₄O, and HMDSO, and it is preferable that the gas containing fluorine elements is further suitably any one of gases of F₂, CHF₃, HF, CF₄, C₂F₄, C₂F₆, C₃F₆, C₄F₆, C₃F₈, C₄F₈, C₅F₈, NF₃ and SF₆.

By such a configuration, the metal oxide film which is thick and has high withstand voltage characteristics can be formed at low temperatures and at high speed, and particularly the glass film, in which visible transmittance is high, and dense and moderate light scattering is attained, can be formed at low temperatures and at high speed.

In accordance with a fourteenth aspect of the present invention, it is characterized in that the metal oxide film is composed of laminated films of two or more layers (which have, for example, the same main component or the same principal element), and a concentration of an impurity at an interface between adjacent laminated films is higher than a concentration of an impurity in each layer of the foregoing laminated films.

By such a configuration, it is possible to obtain the metal oxide film which is thick and has high withstand voltage characteristics and it is possible to obtain particularly the glass film in which visible transmittance is high, and dense and moderate light scattering is attained. Since C elements or F elements are included in each layer of the foregoing laminated films, luminous efficiency can be improved and a dielectric constant can be decreased, and since the concentration of a C element or a F element at an interface between the layers is lower than the concentration of a C element or a F element in each layer of the foregoing laminated films, a reduction in adhesive force at the interface between the layers can be prevented.

Further, since the metal oxide film is composed of laminated films of two or more layers which have the same main component or the same principal element, to produce a thick film having a total thickness of 15 μm, for example, by use of laminated films of two or more layers is more advantageous than to produce a thick film having a thickness of 15 μm, for example, by use of one layer in that warpage due to internal stress is absorbed at the interface between the layers to be reduced and film peeling can be effectively prevented.

In accordance with a fifteenth aspect of the present invention, it is characterized in that the metal oxide film is composed of laminated films of two or more layers (which have, for example, the same main component or the same principal element), and the concentration of a C element or a F element at an interface between adjacent laminated films is lower than the concentration of a C element or a F element in each layer of the foregoing laminated films.

By such a configuration, it is possible to obtain the metal oxide film which is thick and has high withstand voltage characteristics and it is possible to obtain particularly the glass film in which visible transmittance is high, and dense and moderate light scattering is attained.

In the fourteenth and fifteenth aspects of the present invention, it is desirable that the foregoing metal oxide film is suitably an insulating film.

By such a configuration, it is possible to obtain the metal oxide film which is thick and has high withstand voltage characteristics.

In the fourteenth and fifteenth aspects of the present invention, it is desirable that the foregoing metal oxide film is suitably a glass film.

By such a configuration, it is possible to obtain the metal oxide film which is thick and has high withstand voltage characteristics and it is possible to obtain particularly the glass film in which visible transmittance is high, and dense and moderate light scattering is attained.

Further, in the fourteenth and fifteenth aspects of the present invention, it is desirable that the foregoing metal oxide film is suitably a silicon oxide film.

By such a configuration, it is possible to obtain the metal oxide film which is thick and has high withstand voltage characteristics and it is possible to obtain particularly the glass film in which visible transmittance is high, and dense and moderate light scattering is attained.

Further, in accordance with a sixteenth aspect of the present invention, it is desirable that in the fourteenth or fifteenth aspect of the present invention, a thickness of a layer of the foregoing laminated films is suitably 1 to 5 μm and the foregoing interface between layers suitably has a depth of 3 nm or more and 250 nm or less from a boundary surface. The reason for this is that the depth from the boundary surface needs at least a thickness equivalent to one atom and therefore the depth needs at least 3 nm or more, and the thickness of a layer of the foregoing laminated films is 1 to 5 μm and therefore the depth from the boundary surface is desirably 250 nm or less to reduce the loss of light transmittance at a layer of the foregoing laminated films.

By such a configuration, it is possible to obtain the metal oxide film which is thick and has high withstand voltage characteristics and it is possible to obtain particularly the glass film in which visible transmittance is high, and dense and moderate light scattering is attained.

In accordance with a seventeenth aspect of the present invention, it is characterized in that the metal oxide film which is composed of laminated films of two or more layers (which have, for example, the same main component or the same principal element) and in which the concentration of an impurity at an interface between adjacent laminated films is higher than the concentration of an impurity in each layer of the foregoing laminated films is used.

By such a configuration, it is possible to obtain the metal oxide film which is thick and has high withstand voltage characteristics, particularly the glass film in which visible transmittance is high, and dense and moderate light scattering is attained, and the optical electronic device which uses this metal oxide film and has excellent optical characteristics.

In accordance with an eighteenth aspect of the present invention, it is characterized in that the metal oxide film which is composed of laminated films of two or more layers (which have, for example, the same main component or the same principal element) and in which the concentration of a C element or a F element at an interface between adjacent laminated films is lower than the concentration of a C element or a F element in each layer of the foregoing laminated films is used.

By such a configuration, it is possible to obtain the metal oxide film which is thick and has high withstand voltage characteristics, particularly the glass film in which visible transmittance is high, and dense and moderate light scattering is attained, and the optical electronic device which uses this metal oxide film and has excellent optical characteristics.

In the seventeenth and eighteenth aspects of the present invention, it is desirable that the foregoing metal oxide film is suitably an insulating film.

By such a configuration, it is possible to obtain the metal oxide film which is thick and has high withstand voltage characteristics, particularly the glass film in which visible transmittance is high, and dense and moderate light scattering is attained, and the optical electronic device which uses this metal oxide film and has excellent optical characteristics.

In the seventeenth and eighteenth aspects of the present invention, it is desirable that the foregoing metal oxide film is suitably a glass film.

By such a configuration, it is possible to obtain the metal oxide film which is thick and has high withstand voltage characteristics, particularly the glass film in which visible transmittance is high, and dense and moderate light scattering is attained, and the optical electronic device which uses this metal oxide film and has excellent optical characteristics.

Further, in the seventeenth and eighteenth aspects of the present invention, it is desirable that the foregoing metal oxide film is suitably a silicon oxide film.

By such a configuration, it is possible to obtain the metal oxide film which is thick and has high withstand voltage characteristics, particularly the glass film in which visible transmittance is high, and dense and moderate light scattering is attained, and the optical electronic device which uses this metal oxide film and has excellent optical characteristics.

Further, in accordance with a nineteenth aspect of the present invention, it is desirable that in the seventeenth or eighteenth aspect, a thickness of a layer of the foregoing laminated films is suitably 1 to 5 μm and the foregoing interface between the layers suitably has a depth of 3 nm or more and 250 nm or less from a boundary surface.

By such a configuration, it is possible to obtain the metal oxide film which is thick and has high withstand voltage characteristics, particularly the glass film in which visible transmittance is high, and dense and moderate light scattering is attained, and the optical electronic device which uses this metal oxide film and has excellent optical characteristics.

As described above, in accordance with the method for forming the metal oxide film, particularly the glass film, the metal oxide film, particularly the glass film, and the optical electronic device which uses this metal oxide film, of the present invention, it is possible to provide the method for forming a metal oxide film, which is thick and has high withstand voltage characteristics, at low temperatures and at high speed, particularly the method for forming a glass film, in which visible transmittance is high, and dense and moderate light scattering is attained, at low temperatures and at high speed, the metal oxide film which is thick and has high withstand voltage characteristics, particularly the glass film, particularly the glass film in which visible transmittance is high, and dense and moderate light scattering is attained, and the optical electronic device which uses this metal oxide film and has excellent optical characteristics. Further, in the method for forming the metal oxide film, particularly the glass film, of the present invention, since atmospheric pressure plasma is employed, expensive vacuum equipment becomes unnecessary to reduce cost, and since a plasma density is high and time to produce a vacuum becomes unnecessary, the productivity can be improved.

### BRIEF DESCRIPTION OF DRAWINGS

These and other aspects and features of the present invention will become clear from the following description taken in conjunction with the preferred embodiments thereof with reference to the accompanying drawings, in which:

FIG. 1A is a sectional view showing a structure of a glass film in a first embodiment of the present invention;

FIG. 1B is a sectional view showing a structure of a glass film in a modification of the first embodiment of the present invention;

FIG. 1C is a sectional view showing a structure of a glass film in a second embodiment of the present invention;

FIG. 2 is a view of a schematic structure of an apparatus which can perform a die coating step and an atmospheric pressure plasma oxidation step in succession in the first and the second embodiments of the present invention;

FIG. 3 is a sectional view showing a schematic structure of an atmospheric pressure plasma treatment apparatus used in the first and the second embodiments of the present invention;

FIG. 4 is a view showing a comparison between the results of elemental analysis in a layer and between layers of laminated films used in the second embodiment of the present invention;

FIG. 5 is a partial perspective view of a front glass substrate side of a conventional alternating current type (AC type) plasma display panel;

FIG. 6 is a partial perspective view of a rear glass substrate side of the conventional alternating current type (AC type) plasma display panel;

FIG. 7 is a sectional view showing a schematic structure of a plasma CVD apparatus employed in conventional examples;

FIG. 8 is a sectional view showing a schematic structure of a magnesium oxide thin film forming apparatus employed in conventional examples;

FIG. 9A is a sectional view showing a process of forming a layer of a glass film in a conventional example;

FIG. 9B is a sectional view showing a process of forming a layer of a glass film in a conventional example;

FIG. 9C is a sectional view showing a process of forming a layer of a glass film in a conventional example;

FIG. 10 is a sectional view showing a structure of a glass film in a modification of the foregoing embodiment of the present invention; and

FIG. 11 is a sectional view showing a schematic structure of an atmospheric pressure plasma treatment apparatus in a modification of the foregoing embodiment of the present invention.

### DETAILED DESCRIPTION OF THE INVENTION

Before the description of the present invention proceeds, it is to be noted that like parts are designated by like reference numerals throughout the accompanying drawings.

Hereinafter, embodiments of the present invention will be described by reference to drawings.

### First Embodiment

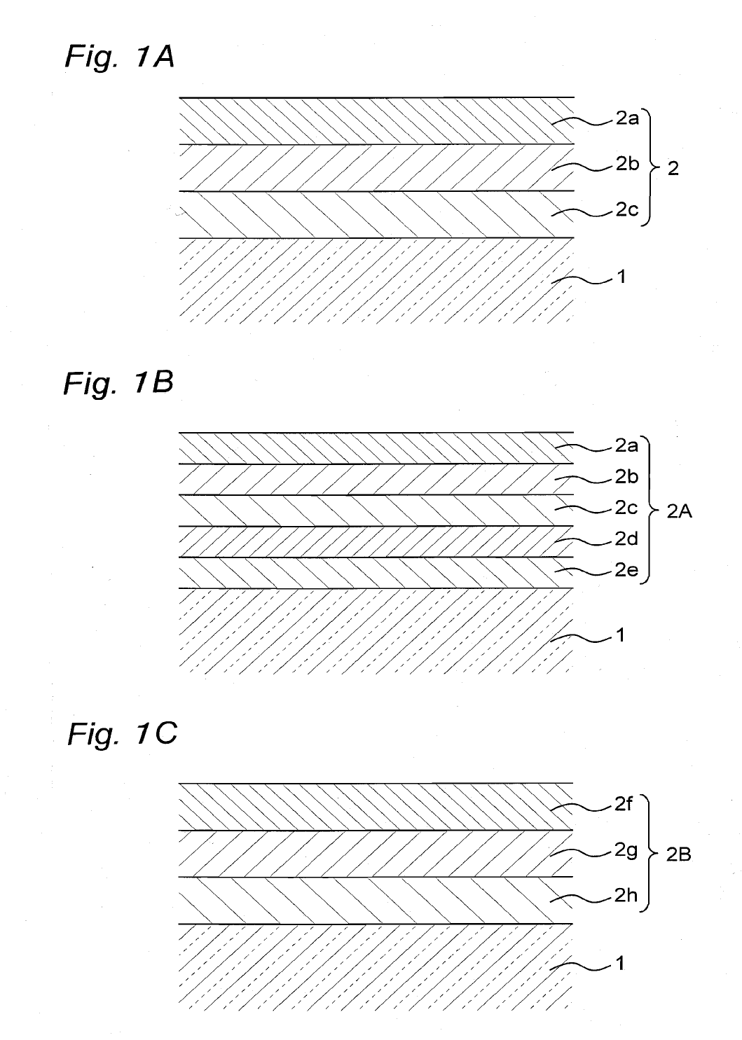

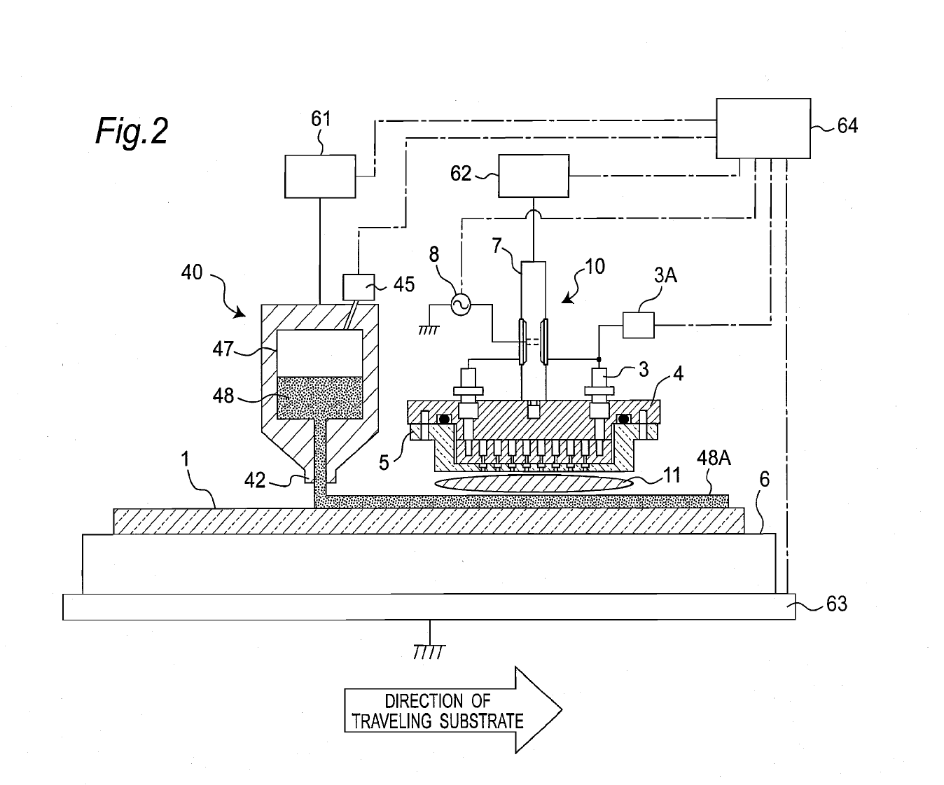

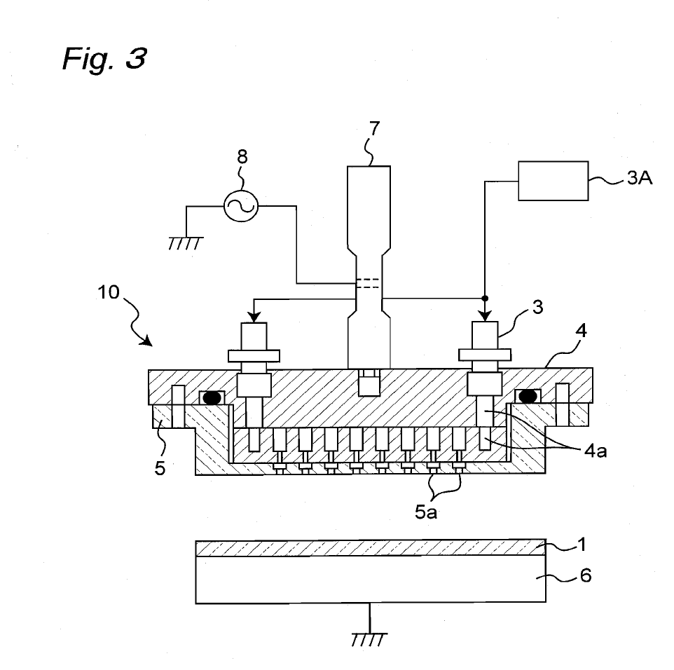

Hereinafter, a method for forming a metal oxide film, a metal oxide film, and an optical electronic device of the first embodiment of the present invention will be described by reference to FIG. 1A, FIG. 1B, FIG. 2, and FIG. 3.

FIG. 1A is a sectional view of the metal oxide film according to the first embodiment of the present invention. A metal oxide film 2 composed of three layers, i.e., layers 2a, 2b, and 2c, is formed on a substrate 1 such as a glass substrate. FIG. 1B is a sectional view of a metal oxide film according to a modification of the first embodiment of the present invention. A metal oxide film 2A composed of five layers, i.e., the foregoing three layers 2a, 2b, and 2c plus two layers 2d and 2e, is formed on a substrate 1 such as a glass substrate.

Hereinafter, a method for forming a glass film as an example of such metal oxide films 2, 2A, particularly a SiO₂ film, will be described.

First, TEOS is used as an example of the organic metal compound that is a liquid at room temperature (15 to 35° C.), and a mixture formed by mixing isobornyl cyclohexanol and ethanol in proportions of about 1:1 by volume is used as an example of the organic solvent, and the foregoing TEOS and the foregoing organic solvent are mixed in proportions of about 4:1 by volume to prepare a paste. In addition, the mixed paste can be formed into a paste not containing bubbles as far as possible by vacuum deaeration.

Next, a step of applying the foregoing paste onto the substrate is performed. As an example of a process of applying the paste onto the substrate, a die coating method or a screen printing method can be used. This die coating method or screen printing method is particularly useful as a method of coating a relatively broad surface in the form of film at high speed.

An example of the die coating method is disclosed in Japanese Patent Publication No. 3457199. A reference numeral 40 in FIG. 2 indicates a schematic sectional view of a die coating nozzle. First the substrate 1 is placed on the grounding electrode 6, and a paste 48 put in a tank 47 of the die coating nozzle 40 is discharged from a head nozzle 42 onto a substrate 1 with a pump 45. The paste 48 is applied onto the substrate 1 to form a paste film 48A while controlling a thickness of the paste 48 so as to have a required thickness on the substrate 1 by adjusting a distance between the head nozzle 42 and the substrate 1 with a lifting and lowering apparatus 61 for a head nozzle depending on the viscosity of paste and moving the substrate 1 relative to the head nozzle 42 with a carrying apparatus 63.

Subsequently, a step of oxidizing a metal element while vaporizing organic substances in the foregoing paste film 48A is performed. As an example of a process of oxidizing a metal element while vaporizing organic substances in the paste film 48A, atmospheric pressure plasma can be used. In this time, the time between the applying step and the oxidizing step is desirably 1 to 60 seconds. The reason for this is that if the time between both steps is less than 1 second, a configuration as facilities is difficult, and if the time between both steps is more than 60 seconds, the paste film 48A applied spreads too far and a film thickness becomes too small.

A schematic view of an atmospheric pressure plasma treatment apparatus used in the process of oxidizing this metal element is shown in FIG. 2 and an enlarged view of the plasma treatment apparatus 10 is shown in FIG. 3. In FIGS. 2 and 3, by introducing a gas from a gas feeding apparatus 3A through a gas introduction port 3 into the atmospheric pressure plasma treatment apparatus 10, the gas can be passed through a gas passage 4a placed within a metal portion 4 located at an upper section of the atmospheric pressure plasma treatment apparatus 10 and can be injected on the substrate 1 from a plurality of gas injection holes 5a placed within a dielectric portion 5 of alumina or the like fixed to a bottom side of the metal portion 4. Furthermore, the grounding electrode 6 is attached to the backside of the substrate 1, and plasma 11 can be generated between the plasma treatment apparatus 10 and the substrate 1 by supplying high-frequency power from a high-frequency power source 8 connected to an application rod 7 connected to a central portion of the metal portion 4 to the metal portion 4 to irradiate the generated plasma 11 to the surface of the substrate 1 under a pressure near an atmospheric pressure. A distance between the plasma treatment apparatus 10 and the substrate 1 can be adjusted with a lifting and lowering apparatus 62 for plasma treatment apparatus. Further, by moving the substrate 1 relative to the plasma treatment apparatus 10 with the carrying apparatus 63, the atmospheric pressure plasma treatment can be applied to the whole paste film 48A. As an example, by performing the plasma treatment at power of 150 W for about 180 seconds on the surface of the substrate 1 using a mixed gas of He and O₂ in a ratio of 95:5, the metal element can be oxidized while vaporizing adequately organic substances in the surface of the substrate 1. In this time, it is generally preferable that as for gas composition for vaporizing and oxidizing, the relationship of 80%≦the concentration of inert gas≦99.9% and 0.1%≦the concentration of O₂ gas≦20% holds. Since a too low concentration of inert gas leads to the reduction in a plasma density and the significant reduction in a treating rate, the concentration of inert gas is preferably 80% or more. On the other hand, since a too high concentration of inert gas leads to the reduction in a chemical reactivity and the treating rate is significantly reduced, the concentration of inert gas is preferably 99.9% or less. Since a too high concentration of O₂ gas leads to the reduction in a plasma density and the significant reduction in a treating rate, the concentration of O₂ gas is preferably 20% or less. On the other hand, since a too low concentration of O₂ gas leads to the reduction in a chemical reactivity and the treating rate is significantly reduced, the concentration of O₂ gas is preferably 0.1% or more.

Here, if plasma is not stabilized and arc discharge occurs in applying this atmospheric pressure plasma to oxidize metal elements, there is an issue that an electrode sustains damage. In order to resolve this issue, in performing the atmospheric pressure plasma treatment, as for the gas composition, He or Ar as an example of inert gas is fed at a concentration of 80% or more (actually 90% or more) and 99.9% or less, and as for the structure of the atmospheric pressure plasma treatment apparatus 10, a substrate side is covered with the dielectric portion 5 of an insulating substance (for example, alumina).

Generally, the plasma treatment hardly proceeds in a direction of depth. In other words, a thickness of a film to be formed by one operation has its limits since a chemical reaction occurs only in the surface of the film targeted for plasma treatment, and for example, the thickness of the film is 1 μm or more and 5 μm or less. In the film having a thickness of less than 1 μm, a uniform thickness cannot be formed, and on the other hand, in the film having a thickness of more than 5 μm, the organic substances not vaporized may remain in the film.

On the other hand, in a conventionally performed method of evaporating the organic substances in the film by heating, there is a limit to the elimination of the organic substances by heating since the glass substrate is melted at a temperature of 50° C. or higher. However, in the atmospheric pressure plasma treatment of the present invention, there is an exceptional advantage that the organic substances can be almost completely eliminated.

Next, a thickness of the metal oxide films 2, 2A can be adjusted to any thickness by alternately repeating more than once the step of applying the paste onto the substrate and the step of oxidizing the metal element in the paste while vaporizing the organic substances in the paste. For example, the metal oxide film 2 of a SiO₂ film having a total thickness of about 15 μm, composed of three layers 2a, 2b, and 2c by forming a layer having a thickness of about 5 μm three times, can be formed by repeating three times the sequence of applying the paste 48 in a thickness of about 7 μm to form a paste film 48A and performing the atmospheric pressure plasma treatment at power of 150 W for about 180 seconds on the paste film 48A thus formed, using a mixed gas of He and O₂ in a ratio of 95:5. That is, when the metal oxide film 2 is composed of three layers 2a, 2b, and 2c as shown in FIG. 1A, the paste film 48A of one layer is formed on the substrate 1 by the application of the paste 48 and then the atmospheric pressure plasma treatment is performed on the paste film 48A to form the layer 2a. Next, a paste film 48A of another layer is formed on the layer 2a by the application of the paste 48 and then the atmospheric pressure plasma treatment is performed on the paste film 48A to form the layer 2b. Next, a paste film 48A of another layer is formed on the layer 2b by the application of the paste 48 and then the atmospheric pressure plasma treatment is performed on the paste film 48A to form the layer 2c. The metal oxide film 2 of three layers 2a, 2b, and 2c can be formed on the substrate 1 in this way. Further, when the metal oxide film 2 is composed of five layers 2a, 2b, 2c, 2d, and 2e as shown in FIG. 1B, a paste film 48A of another layer is further formed on the layer 2c by the application of the paste 48 and then the atmospheric pressure plasma treatment is performed on the paste film 48A to form the layer 2d. Next, a paste film 48A of another layer is formed on the layer 2d by the application of the paste 48 and then the atmospheric pressure plasma treatment is performed on the paste film 48A to form the layer 2e. The metal oxide film 2A of five layers 2a, 2b, 2c, 2d, and 2e can be formed on the substrate 1 in this way.

In addition, the operations of the above-mentioned pump 45, lifting and lowering apparatus 61 for head nozzle, carrying apparatus 63, lifting and lowering apparatus 62 for plasma treatment apparatus, gas feeding apparatus 3A, and high-frequency power source 8 are controlled by a control apparatus 64 and the foregoing steps can be performed in turn.

A die coating system is configured so as to move the substrate 1 relative to the head nozzle 42 with the carrying apparatus 63, but the system is not limited to this. The head nozzle 42 and the plasma treatment apparatus 10 may be moved relative to the substrate 1 with a carrying apparatus.

The metal oxide film 2, 2A obtained by such a method is a SiO₂ film which can be formed at low temperatures (e.g., room temperature) and at high speed even though it is a thick film (for example, a thick film having a thickness of 1 μm or more and 1 mm or less (preferably 50 μm or less)) of the order of micrometers. Accordingly, high withstand voltage characteristics, high visible transmittance, a high dense property and moderate light scattering can be achieved. Therefore, an optical electronic device which uses this metal oxide film 2 or 2A and has excellent optical characteristics can be obtained. Further, in the method for forming the metal oxide film of the first embodiment, since atmospheric pressure plasma is employed, expensive vacuum equipment becomes unnecessary to reduce cost, and since a plasma density is high and time to produce a vacuum becomes unnecessary, the productivity can be improved.

### Second Embodiment

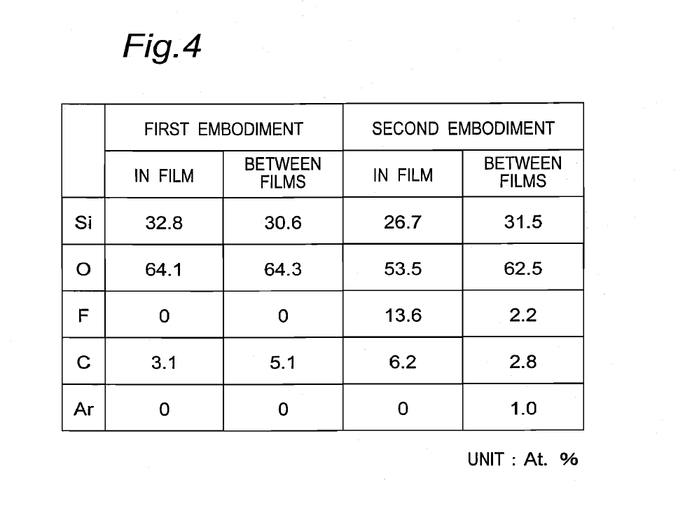

Hereinafter, a method for forming a metal oxide film, a metal oxide film, and an optical electronic device of a second embodiment of the present invention will be described by reference to FIG. 1C and FIG. 4.

FIG. 1C is a sectional view of a metal oxide film according to the second embodiment of the present invention. A metal oxide film 2B composed of three layers, i.e., layers 2f, 2g, and 2h, is formed on a substrate 1 such as a glass substrate.

Hereinafter, a method for forming a glass film as an example of such a metal oxide film 2B, particularly a SiO₂ film, will be described. The step of mixing the organic metal compound that is a liquid at room temperature (15 to 35° C.) and the organic solvent to form a paste, the step of applying the paste 48 onto the substrate 1, and the step of oxidizing the metal element while vaporizing the organic substances in the paste film 48A can be performed by the same means and under the same conditions as in the respective steps of the first embodiment. This step is different from the first embodiment in that in performing the atmospheric pressure plasma treatment in the step of oxidizing the metal element while vaporizing the organic substances in the paste film 48A, and the atmospheric pressure plasma treatment is performed at power of 150 W for 120 seconds using a mixed gas of He, O₂, and CF₄ in a ratio of 92:5:3, formed by adding a CF₄ gas to the mixed gas of He and O₂, and thereafter, the atmospheric pressure plasma treatment is performed at power of 150 W for 30 seconds using the mixed gas of He and Ar in a ratio of 92:8. In this time, it is generally preferable that as for gas composition for vaporizing and oxidizing, the relationship of 80%≦(the concentration of inert gas such as He or Ar)≦99.9%, 0.1%≦(the concentration of O₂ gas)≦20%, and 0.1≦(O₂ gas/F-containing gas)≦10.0 holds. Further, it is preferable that a ratio (O₂ gas/F-containing gas) is modified depending on the gas species of the F-containing gas, and it is preferable that the ratio (O₂ gas/F-containing gas) is increased with increase in number of F elements in 1 mol of gas. For example, when a C₂F₆ gas is used, it is desirable that the ratio (O₂ gas/F-containing gas) is 1 or more, and generally about 1.5 in order to achieve an effect equivalent to the case where a CF₄ gas is used and the ratio (O₂ gas/F-containing gas) is 1.

In addition, since a too low concentration of inert gas such as He or Ar leads to the reduction in a plasma density and the significant reduction in a treating rate, the concentration of inert gas such as He or Ar is preferably 80% or more. On the other hand, since a too high concentration of inert gas such as He or Ar leads to the reduction in a chemical reactivity and the treating rate is significantly reduced, the concentration of inert gas such as He or Ar is preferably 99.9% or less. Since a too high concentration of O₂ gas leads to the reduction in a plasma density and the significant reduction in a treating rate, the concentration of O₂ gas is preferably 20% or less. On the other hand, since a too low concentration of O₂ gas leads to the reduction in a chemical reactivity and the treating rate is significantly reduced, the concentration of O₂ gas is preferably 0.1% or more.

If the ratio (O₂ gas/F-containing gas) is mostly less than 0.1, it is not preferable because elements, other than F, contained in the F-containing gas tend to form a by-product such as a colored deposit. Further, if the ratio is mostly more than 10.0, a degree of an oxidation reaction by the O element at the surface to be treated becomes much larger than that of a fluorination reaction by the F element and a desired effect such as a reduction in a dielectric constant becomes hard to achieve. Accordingly, preferably, the ratio (O₂ gas/F-containing gas) is mostly 0.1 or more and 10.0 or less.

Then, a thickness of the metal oxide films 2B can be adjusted to any thickness by alternately repeating more than once the step of applying the paste 48 onto the substrate 1 and the step of oxidizing the metal element in the paste film 48A while vaporizing the organic substances in the paste film 48A in a similar way to the first embodiment. For example, the metal oxide film 2B of a SiO₂ film having a total thickness of about 15 μm, composed of three layers 2f, 2g, and 2h by forming a layer having a thickness of about 5 μm three times, can be formed by repeating three times the sequence of applying the paste 48 in a thickness of about 7 μm to form a paste film 48A, and then performing the atmospheric pressure plasma treatment at power of 150 W for about 120 seconds on the paste film 48A thus formed using a mixed gas of He, O₂, and CF₄ in a ratio of 92:5:3, and then performing the atmospheric pressure plasma treatment at power of 150 W for about 30 seconds on the paste film 48A using a mixed gas of He and Ar in a ratio of 92:8.

By adding a gas containing F elements such as a CF₄ gas to the mixed gas of He and O₂ like this second embodiment, there is an advantage that a rate of reaction with organic components is improved and the vaporization of the organic components can be performed in a significantly short time. However, when an amount of the CF₄ gas to be added is large, since a ratio of SiOF in the SiO₂ film increases, a dielectric constant is reduced from the fact that a relative permittivity of SiO₂ is 4.0 to 4.5 and on the other hand, a relative permittivity of SiOF is 3.4 to 3.6, and therefore a luminous efficiency is improved. Accordingly, adjustments of addition amount become necessary depending on required film characteristics.

In addition, the SiOF is relatively easy to control impurities as a low dielectric constant material based on SiO₂. In the second embodiment of the present invention, as described above, SiOF can be easily produced by adding the F-containing gas (NF₃, CF₄, C₂F₆, or the like) to plasma in the oxidizing step after forming the paste film by application of the paste. On the other hand, in the case of SiOC described later, H or OH existing due to water content in air is apt to be combined with a C element, and the metal oxide film tends to become a film including high contents of impurities such as H or OH group and hardly becomes homogeneous composition. However, there is an advantage that a relative permittivity of the SiOC is smaller than that of the SiOF (The relative permittivity of the SiOF is 3.4 to 3.6, and on the other hand, the relative permittivity of the SiOC is 2.7 to 2.9).

In the surface of the SiO₂ film formed, an adhesive force between layers may be deteriorated since the C elements and the F elements composing the addition gas exist in large numbers. Thus, by performing the plasma treatment on the surface of the formed film with a mixed gas based on the inert gas such as He or Ar, impurity elements can be eliminated and the adhesive force between layers can be improved. An elemental analysis was performed on a cross section exhibiting states in a layer and between layers in SiO₂ laminated films using XPS (X-ray photoelectron spectroscopy): a technique of analyzing elemental composition of from lithium (Li) to uranium (U) and chemical bonding states by irradiating X-rays to the surface of a sample and measuring photoelectrons generated from the surface. The results of analysis are shown in FIG. 4. As shown above, by the atmospheric pressure plasma treatment performed in the second embodiment, the C elements and the F elements, a relatively large number of which are detected in each layer of a multilayer structure of the metal oxide film 2B, become slight at the interface between adjacent layers and a trace amount of Ar comes to be detected.

The metal oxide film 2B obtained by such a method is a SiO₂ film which can be formed at low temperatures (e.g., room temperature) and at high speed even though it is a thick film (for example, a thick film having a thickness of 1 μm or more and 1 mm or less (preferably 50 μm or less)) of the order of micrometers. Accordingly, high withstand voltage characteristics, high visible transmittance, a high dense property and moderate light scattering can be achieved. Therefore, an optical electronic device which uses this metal oxide film 2B and has excellent optical characteristics can be obtained. Further, also in the method for forming a metal oxide film of the second embodiment, since atmospheric pressure plasma is employed, expensive vacuum equipment becomes unnecessary to reduce cost, and since a plasma density is high and time to produce a vacuum becomes unnecessary, the productivity can be improved.

In the embodiment of the present invention, each of the metal oxide films 2, 2A, 2B is formed so as to be composed of a multilayer structure. The reason for this is as follows. Generally, film stress produced between a substrate and a film layers is increased with the increase in a film thickness. Large film stress is not preferable because cracking is produced in the film or film peeling occurs. For example in the case where the SiO₂ film is formed on soda-lime glass by the CVD method, cracking tends to be produced in the film at room temperature when the film thickness is mostly more than 5 μm even though a main component of the film is the same SiO₂ as the substrate. Furthermore, in the case where heat resistance of about 500° C. is also required, cracking tends to be produced in the film when the film thickness is mostly more than 2 μm.

Accordingly, when a film having a thickness of mostly 1 μm or more is formed, a contrivance to prevent cracking or film peeling becomes necessary. The present invention has an advantage that the film stress produced between a substrate and a film layers can be reduced by forming a film having a thickness of 15 μm more than once (e.g., by forming a film having a thickness of 5 μm at three times). It is thought that film stress at the interface between adjacent layers of a plurality of layers composing a film is also reduced.

In addition, in the steps of mixing an organic metal compound that is a liquid at room temperature and an organic solvent to form a paste and applying the paste formed into the paste onto the substrate in the present invention, the paste may be applied onto the substrate by a sol-gel method to form a paste film. That is, as an example of the sol-gel method, the metal oxide film can be produced by undergoing the steps of mixing at least three kinds of materials of TEOS, water, and acid or alkali to form a paste, applying the paste formed into the paste onto the substrate to form a paste film, and oxidizing the formed paste film.

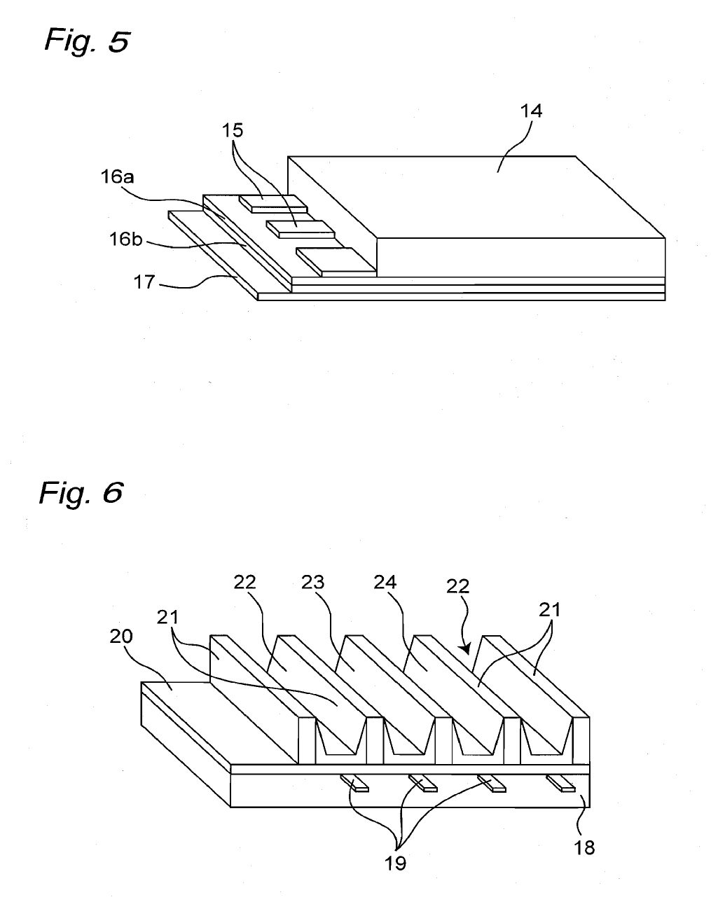

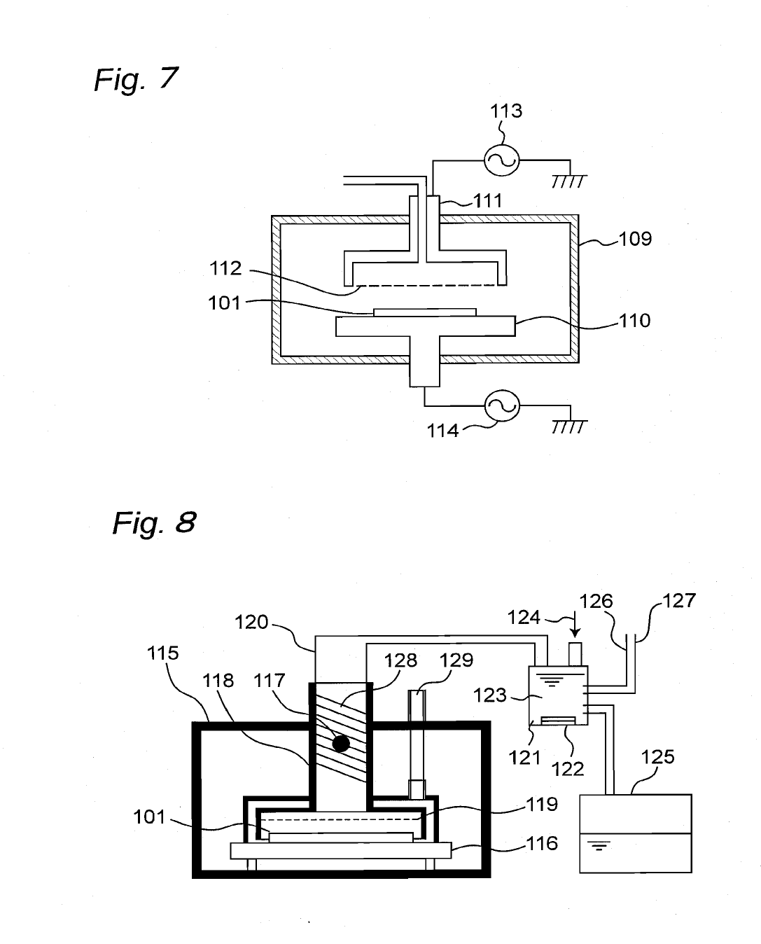

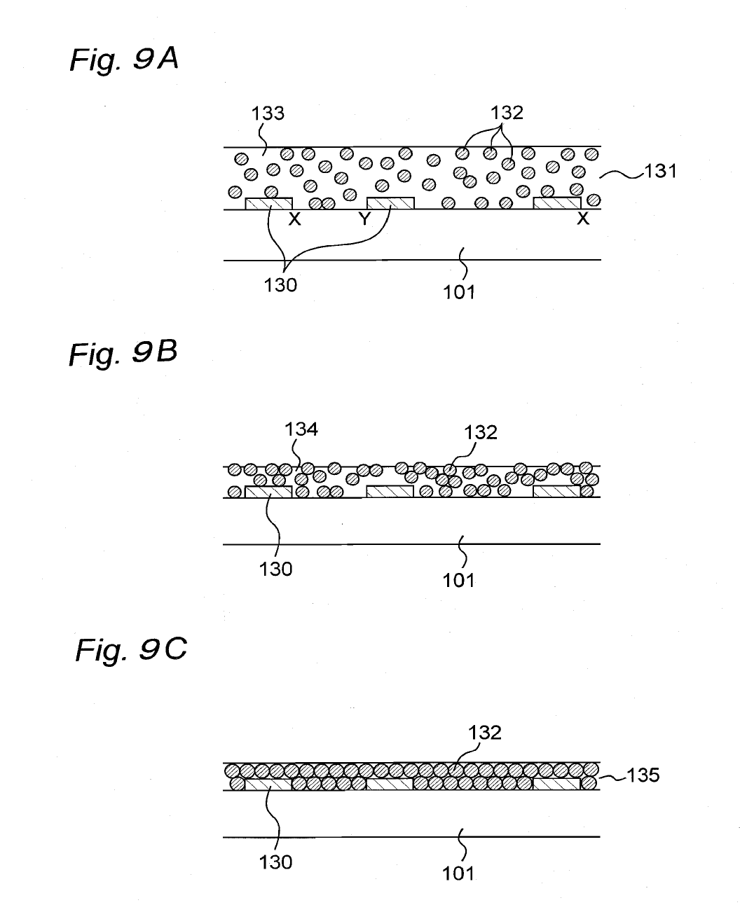

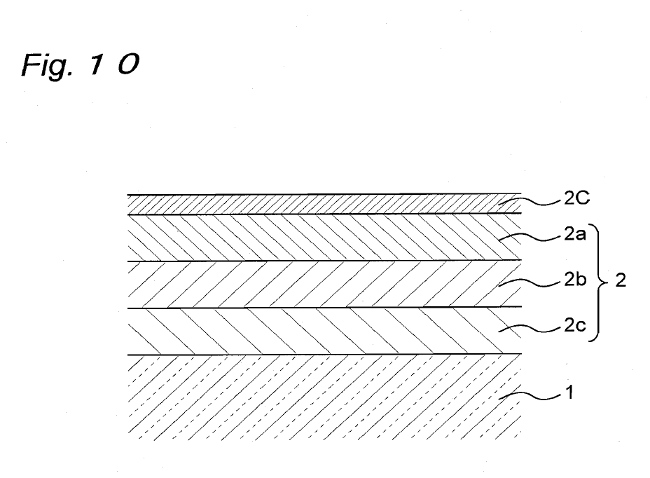

By the way, in the first and second embodiments in the present invention, the metal oxide film formed on the glass substrate is exemplified, but the present invention can be applied to, for example, a plasma display panel (hereinafter, referred to as a “PDP”) as an optical electronic device using the metal oxide film. The structure of the PDP is as follows. FIGS. 5 and 6 show a known alternating current type (AC type) plasma display panel. In FIG. 5, a reference numeral 14 indicates a front glass substrate made of sodium borosilicate glass by a float process or lead glass, and display electrodes exists on this front glass substrate 14 composed of silver electrodes or Cr—Cu—Cr electrodes 15, and dielectric glass layers 16a, 16b, serving as capacitors, which are formed by use of glass powder having an average particle diameter of 0.1 to 20 μm, and a magnesium oxide (MgO) dielectric protective layer 17 cover these display electrodes 15. In FIG. 6, a reference numeral 18 indicates a rear glass substrate, and address electrodes (an ITO and silver electrodes or Cr—Cu—Cr electrodes) 19 and a dielectric glass layer 20 are provided on this rear glass substrate 18, and barrier ribs 21 and phosphor layers 22, 23, 24 are provided on the dielectric glass layer 20, and a space between adjacent barrier ribs 21 is a discharge space in which a discharge gas is encapsulated and a space where the phosphor layer 22 or 23 or 24 is formed. Here, the dielectric glass layers 16a, 16b and the dielectric glass layer 20 correspond to the metal oxide film.

Further, in the embodiments in the present invention, only the SiO₂ film is described, but the present invention can be applied to other metal oxide films. Examples of other metal oxide films include GeOx, BOx, POx, WOx, SbOx, TiOx, AlOx, MgOx, NbOx, LiOx, and the like. Particularly, applications as an insulating film are desirable, and this metal oxide film performs a special effect in the glass film or a highly transparent film among them.

In addition, in the embodiments in the present invention, only the case where the organic silicon compound, especially TEOS, is used as the organic metal compound is described, substances being liquid at room temperature, for example, HMDSO (hexamethyldisiloxane), Ge(OC₂H₅)₄, B(OC₂H₅)₃, B(OCH₃)₃, PO(OCH₃)₃, PO(OC₂H₅)₃, P(OCH₃)₃, W(OC₂H₅)₅, Sb(OC₂H₅)₃, titanium isopropoxide, aluminum isopropoxide, magnesium isopropoxide, niobium ethoxide, lithium ethoxide, or the like may be used and a desired metal oxide film can be formed.

Further, it is desirable that a volume ratio of the organic solvent in the paste is 10% or more and 80% or less. When the volume ratio is less than 10%, desired viscosity cannot be attained and a thickness of a film to be formed by one application becomes too small, and therefore the number of steps and time required for forming the metal oxide film having a desired thickness is increased. While when the volume ratio is more than 80%, volume contraction due to the vaporization of organic substances is increased, and therefore it becomes difficult to attain a homogeneous film. It is desirable that the volume ratio of the organic solvent is further preferably 20% or more and 60% or less.

Further, it is desirable that the viscosity of the paste 48 is 10 mPa·s or more and 50 Pa·s or less at room temperature. When the viscosity of the paste is less than 10 mPa·s, a thickness of a film to be formed by one application of the paste becomes too small, and therefore the number of steps and time required for forming the metal oxide film having a desired thickness is increased. When the viscosity of the paste is more than 50 Pa·s, it becomes difficult to control the discharge of the paste and to obtain a homogeneous film. It is desirable that the viscosity of the paste is further preferably 50 mPa·s or more and 1 Pa·s or less at room temperature

Further, in the above-described embodiments in the present invention, only the die coating method is described as the application process, but the present invention can be applied using another application process. It is preferable to select the application process depending on an area at which a film is to be formed and film characteristics (uniformity, film thickness) required.

In addition, the atmospheric pressure plasma is used as the means for oxidizing, and when the atmospheric pressure plasma is used, there are special advantages that an oxidation treatment can be performed (without moving the substrate) immediately after applying the paste onto the substrate, chemically active O elements can be supplied to the substrate, and the metal oxide film can be produced in an extremely shot time. However, other oxidation means, for example, a thermal oxidation treatment or an ozone treatment, may be employed and a desired metal oxide film can be formed.

By adding a gas having a high C element content such as a C₄F₈ gas to the mixed gas of He and O₂, a glass film containing SiOC in the proportion of a certain level can be produced. It is preferable to add the C element depending on a film characteristic required since the addition of the C elements has an advantage that an optical electronic device, in which the glass film is used as an insulating film having a low dielectric constant and a charge loss is small, can be prepared

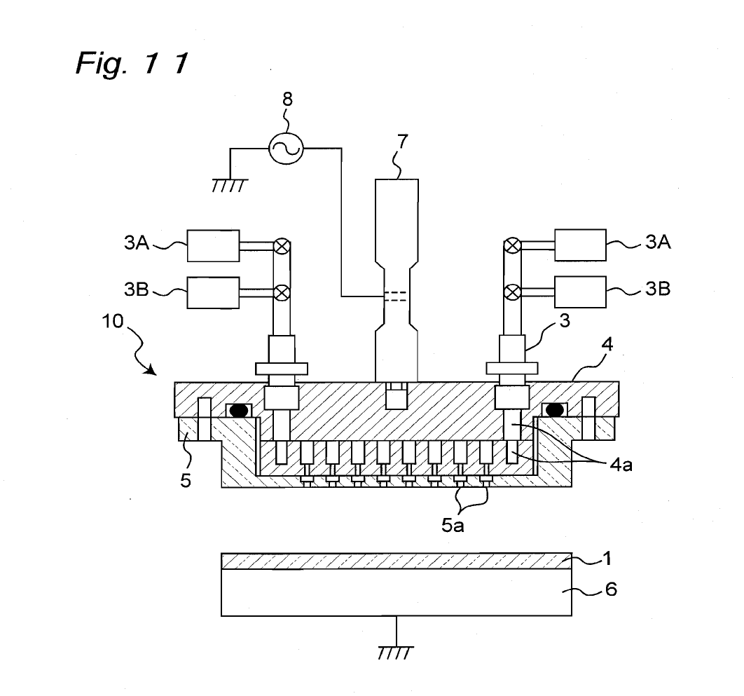

Further, as shown in FIG. 10, in the above-described embodiment of the present invention, a step of depositing a second metal oxide film 2C on the metal oxide films 2, 2A, 2B (in FIG. 10, these are epitomized by the metal oxide film 2, but in the case of the metal oxide film 2A or 2B, the metal oxide film 2A or 2B is formed in a position of the metal oxide film 2) formed in the step of oxidizing a metal element while vaporizing organic substances in the paste 48 by the CVD method may be added. For example, as shown in FIG. 11, a SiO₂ film having a thickness of the order of nanometers can be further formed by use of a mixed gas of gaseous TEOS, He gas, and O₂ gas fed from a gas feeding apparatus 3B in a separate system according to the atmospheric pressure plasma method after forming a SiO₂ film through the application of TEOS onto the substrate 1 and the oxidation of a metal element by the atmospheric pressure plasma, as with the above-described embodiment of the present invention. The addition of this step has an advantage that an adhesive force between layers of a multilayer film is improved.

Further, in the step of applying the paste 48 onto the substrate 1, it is desirable that a thickness of the film to be applied by one application is 1 μm or more and 10 μm or less. When the thickness of the film to be applied is less than 1 μm, it becomes difficult to control a gap (distance) between the substrate and applying equipment (a nozzle) and to obtain a homogeneous film. When the thickness of the film to be applied is more than 10 μm, volume contraction due to the vaporization of organic substances is increased, and therefore it becomes difficult to attain a homogeneous film.

Further, in the above-described embodiment in the present invention, the glass plate is exemplified as the substrate 1, but the substrate is not limited to this and various substrates such as a Si substrate, a compound semiconductor substrate, and the like can be employed. Particularly, a substrate having an organic substance as a main component is preferable. For example when polyimide, Teflon (registered trademark), polycarbonate, a PET film, or an organic semiconductor is used as a substrate, since a film can be formed at low temperatures, a desired metal oxide film can be formed without causing deformation or melting of the substrate.

The glass film thus obtained can be used in optical electronic devices. As an example, an optical waveguide is conceivable. Alternatively, a display of a PDP or the like is conceivable. In these devices, since the glass film becomes a passage of visible light, high light transmittance is required. The glass film requires a thickness of 10 μm or more. Further, in the PDP, since a high voltage is applied to a discharge space through the glass film, the glass film requires high withstand voltage characteristics. In order to secure mechanical durability/heat durability of the device, a dense property is required. In displays such as PDPs, liquid crystal displays, and the like, an improvement in viewing angle can be expected since moderate light scattering is attained.

Alternatively, moderate light scattering allows the glass film to be used as floor or wall materials of bathrooms or water-repellent and stain-proofing materials of sanitary fitments.

By properly combining the arbitrary embodiments of the aforementioned various embodiments, the effects possessed by the embodiments can be produced.

### INDUSTRIAL APPLICABILITY

In accordance with the present invention, it is possible to provide the method for forming the metal oxide film (for example, a glass film) having excellent characteristics, the metal oxide film (for example, a glass film) having excellent characteristics, and the optical electronic device which uses this metal oxide film. Accordingly, the metal oxide film of the present invention can be used for the production of displays to be used for image display of TV sets or computers, and can be also employed as building materials.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

1-13. (canceled)

14. A metal oxide film of SiO₂ comprising laminated films of two or more layers, wherein a concentration of an F element at each of adjacent interfaces of adjacent laminated films thereof is lower than a concentration of an F element in each layer of the adjacent laminated films.

15. (canceled)

16. The metal oxide film according to claim 14, wherein a thickness of a layer of the laminated films is 1 to 5 μm and the interface has a depth of 3 nm or more and 250 nm or less from a boundary surface.

17. An optical electronic device using a metal oxide film of SiO₂ comprising laminated films of two or more layers, in which a concentration of an F element at each of adjacent interfaces of adjacent laminated films thereof is lower than a concentration of an F element in each layer of the adjacent laminated films.

18. (canceled)

19. The optical electronic device according to claim 17, wherein a thickness of a layer of the laminated films is 1 to 5 μm and the interface has a depth of 3 nm or more and 250 nm or less from a boundary surface.
